(19) United States
(12) Patent Application Publication
(10) Pub. No.: US 2023/0026549 A1
(43) Pub. Date: Jan. 26, 2023

(54) STRUCTURAL CELL TO PACK BATTERY

(71) Applicant: Our Next Energy, Inc., Novi, MI (US)

(72) Inventors: Mujeeb Ijaz, West Bloomfield, MI (US); Jason Davis, Livonia, MI (US); Tim Hughes, South Lyon, MI (US); Dylan Propst, Plymouth, MI (US)

(21) Appl. No.: 17/865,001

(22) Filed: Jul. 14, 2022

Related U.S. Application Data
(60) Provisional application No. 63/221,783, filed on Jul. 14, 2021.

(51) Int. Cl. H01M 10/6556; H01M 10/613; H01M 10/6568; H01M 50/249; H01M 50/209; H01M 10/615

(52) U.S. Cl. CPC H01M 10/6556; H01M 10/613; H01M 10/6568; H01M 50/249; H01M 50/209; H01M 10/615; H01M 2220/20

(57) ABSTRACT

A battery pack that includes an enclosure having at least four sidewalls and a base. An array of cells is arranged on the base, with each of the cells having a large wall surface and a small wall surface. The cells are arranged such that the large wall surfaces are parallel to each other. Components of the enclosure are made from an extrusion process and are mechanically attached or welded together. A base of the enclosure has fluid channels formed from the extrusion for use in cooling the array of cells.

### TECHNICAL FIELD

The present invention relates generally to a battery pack. More particularly, the present invention relates to a battery pack with an enclosure for storing battery cells.

### BACKGROUND

Battery systems are used to serve as energy sources for electrical devices and in energy-storage solutions. Battery systems are typically made from several components, including individual cells, electrical current transmission systems, safety systems, etc. Electric vehicle (EV) batteries are used to power the electric motors of electric vehicles. These batteries are usually rechargeable batteries, that are typically made of Lithium-Ion. EV batteries are usually constructed as nested elements. A battery pack typically holds several battery modules, each of which is includes a plurality of cells that are stacked together and adapted to generate power. Inside each cell, lithium atoms move through an electrolyte between a graphite anode and a cathode sheet composed of a metal oxide.

The battery modules may have individual housings that seals the cells from the harsh operating environments of temperature extremes, water ingress, humidity and vibration in which these cells work.

### SUMMARY

The illustrative embodiments disclose a battery pack and method of producing a battery pack. In as aspect herein, the battery pack may include an enclosure that has at least four sidewalls connected by a base. The enclosure also may have a plurality of cells arranged on one or more rows of the base, with each of the plurality of cells having a large wall surface and a small wall surface, a surface area of the small wall surface being less that a surface area of the large wall surface. For each row of the one or more rows, cells of the plurality of cells may be arranged such their large wall surfaces are parallel to each other. Further, a body of the enclosure is made from extruded parts.

In another aspect, two sidewalls of the at least four sidewalls may be end plates that are arranged parallel to the large wall surfaces with one of the two sidewalls being adaptable to apply compressive force to the plurality of cells.

In yet another aspect, the at least four sidewalls may be mechanically attached or welded to the base.

In some implementations, the enclosure may include an electronics compartment that houses one or more battery pack electronics control modules. In some implementations, the battery pack electronic control modules may include one or more modules selected from the list consisting of a Battery Energy Control Module (BECM), a sensor module(s), a high voltage connector and a low voltage connector.

The base may be an extrusion that includes a plurality of fluid channels configured to cool the battery pack. In such an arrangement, the plurality of fluid channels may extend along a length of the base. At least one channel of the plurality of fluid channels may have an undulating or substantially undulating profile that maximizes a surface area of said at least one channel in comparison with a conventional channel having a substantially rectangular profile. The base may also have a footer made from machined-off fins at a first end of the battery pack to allow flow of the cooling liquid from first fluid channels at one end of a channel section to second fluid channels at another end of the channel section.

In some implementations, one or more heating elements may be disposed across a length of the base.

In other implementations, at least 70 percent of a volume of the battery pack may be occupied by cells.

Further, each row of the at one or more rows may have a same number of cells. The battery pack may also have at least two rows and each row may be separated from an adjacent row by a divider.

In some implementations, two sidewalls of the at least four sidewalls may have one or more projections or vehicle mounts adapted for attaching the battery pack to a base of an electric vehicle.

In some implementations, two other sidewalls of the at least four sidewalls may be arranged opposite each other along a plane of the small wall surface to apply compressive force to the plurality of cells. The battery pack may further include one or more busbars connected to the plurality of cells through electrical connectors.

Another aspect relates to a battery pack that includes an enclosure that has at least four sidewalls connected by a base, the base being an extrusion. The battery pack may have a first endplate that forms one of said at least four sidewalls, where the first endplate is configured to be welded or attached to the base to apply compressive load to a plurality of cells, a body of the enclosure is made from extruded parts and the at least four sidewalls are mechanically attached or welded to the base.

Yet another aspect is related to a method of producing a battery pack. The method may include the step of forming an enclosure that includes a base and at least four sidewalls, the base being formed by an extrusion process to include a plurality of fluid channels. The method also may include providing a plurality of cells, with each of the plurality of cells having a large wall surface and a small wall surface, a surface area of the small wall surface being less that a surface area of the large wall surface. The plurality of cells may be arranged on the base such that their large wall surfaces are parallel to each other. The plurality of cells may be compressed using a first end plate by applying said first end plate to the plurality of cells in a direction perpendicular to the large wall surfaces, and at least one of the sidewalls is mechanically attached or welded to the base.

The method further may include creating a pressure differential, by the use of a pump, to move a cooling liquid through the plurality of fluid channels to cool the plurality of cells.

The method also may include providing one or more heating elements disposed on the base to heat the plurality of cells in cold temperatures.

An electronics compartment may be formed as part of the enclosure and may be disposed on a second end of the battery pack to house one or more battery pack electronics control modules.

Fins of the base may be machined off to create a footer at a first end of the battery pack, opposite the second end, to allow flow of the cooling liquid from first fluid channels at one end of a channel section to second fluid channels at another end of the channel section to cool the plurality of cells.

An aspect of the method includes forming the enclosure and arranging the plurality of cells on the base of the enclosure such that at least 70% of a volume of the battery pack is occupied by the plurality of cells.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

To easily identify the discussion of any particular element or act, the most significant digit or digits in a reference number refer to the figure number in which that element is first introduced. Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a drivetrain and energy storage components in accordance with an illustrative embodiment.

FIG. 2 depicts a diagram of a battery pack arrangement in accordance with an illustrative embodiment.

FIG. 3 depicts a perspective view of a battery pack in accordance with an illustrative embodiment.

FIG. 4A depicts a perspective view of a battery pack enclosure in accordance with an illustrative embodiment.

FIG. 4B depicts a top view of a battery pack enclosure in accordance with an illustrative embodiment.

FIG. 5 depicts a perspective view of one end of a battery pack enclosure having a first end plate in accordance with an illustrative embodiment.

FIG. 6 depicts a perspective view of a battery pack in accordance with an illustrative embodiment.

FIG. 7A depicts a perspective view of a base of a battery pack in accordance with an illustrative embodiment.

FIG. 7B depicts a side view of a base of a battery pack in accordance with an illustrative embodiment.

FIG. 7C depicts a transverse cross-sectional view of a base of a battery pack in accordance with an illustrative embodiment.

### DETAILED DESCRIPTION

The illustrative embodiments described herein are directed to battery pack having an enclosure that houses a plurality of cells. In an illustrative embodiment, the cells are arranged to maximize cell volume to battery pack volume.

Conventional designs for high-voltage battery packs typically use groupings of battery cells arranged into modular building blocks, which are then installed into a larger pack enclosure. The cell modules typically provide location and constraint to the cells, with the outer pack enclosure providing restraint and protection to the cells. In some cases, a separate cooling system may be used within the pack to provide temperature management to the cells. In contrast, embodiments disclosed herein may arrange the battery cells directly in the pack enclosure, entirely bypassing modular building blocks such as those used in conventional arrangements. Embodiments disclosed herein may thereby eliminate duplication of physical structures in a high-voltage battery pack to locate, constrain, restrain, and structurally protect the battery cells by directly providing these functions with the battery pack enclosure without the need for separate cell modules. Further, cooling and cell temperature management may be integrated directly within the enclosure. This may allow for smaller overall packaging than is achievable using conventional arrangements. This may result, for example, in significant increases to the volumetric energy density of the battery pack, as well as other advantages and improvements as disclosed herein. As used herein, a “battery pack” refers to such a battery device or component. In contrast, battery “cells” or “modules” are internal components that are contained within a battery pack, and which typically are not designed or suited for direct use in, for example, EV applications as disclosed herein. For example, battery cells or modules typically are not as protected from the external ambient environment as the battery pack containing them, and usually are not placed in locations where they would be directly exposed to the ambient environment (though they may contain some level of sealing or other protection from expected operating conditions). Generally cells and modules are not expected to operate directly within a vehicle or other device but are contained within a battery pack as disclosed herein. A battery pack also may include vehicle mounts or equivalent components as disclosed herein, whereas cells or modules are not designed for direct attachment to the vehicle.

One or more embodiments recognize that an existing problem in battery pack manufacturing is the need to maximize the power output of battery packs. One or more embodiments further recognize that significantly increasing the percentage of battery pack volume occupied by cells requires tremendous technical expertise. Current EV battery packs are composed of a number of individual modules grouped together to form the full battery pack. The individual modules are further sealed inside the battery packs, making it difficult to swap out. More modules means more hardware for enclosing each additional module, connecting said each additional module electrically and connecting said each additional module to a thermal management system which inevitably adds weight and cost to the battery pack. For example, conventional high-voltage battery packs typically build groups of battery cells into modular building blocks or a plurality of cell modules that are individually installed into a larger pack enclosure. The cell modules provide location and constraint to the component cells and the outer pack enclosure provides restraint and protection to said component cells. A separate cooling system within the pack provides temperature management to the cells. The illustrative embodiments recognize that these conventional battery packs typically have a low percentage of their volume being occupied by the cells (about 32%) due to, for example, duplication of cell constraining and location elements. The embodiments thus recognize a need to eliminate the duplication of physical structures, in a high-voltage battery pack, to locate, constrain, restrain, and structurally protect component cells by directly providing these functions using the battery pack enclosure without the need for separate cell modules. Further, the integration of cooling and cell temperature management structure directly within the enclosure, as described hereinafter, creates a smaller battery pack enclosure than the size of conventional battery pack enclosures. The result is a significant increase in the volumetric energy density of the battery pack.

One or more embodiments are directed to a battery pack having an enclosure configured to house an arrangement of cells to maximize cell volume to pack volume ratio which in turn maximizes the volumetric energy density of the battery pack in comparison to conventional battery packs. In one embodiment, the percentage of the battery pack volume occupied by cells is at least 70% (e.g. 73% or 70-80%). In another embodiment, cell weight to battery pack weight is at least 80% (e.g. 85% or 80-90%). This significantly increases the range available for electric vehicles.

In another embodiment, the battery pack includes a thermal management system to control the temperature of cells in the enclosure. In another embodiment, the battery pack includes a compartment to house electronics and a battery management system of the battery pack. In a further embodiment, the battery pack enclosure has mechanical parts with components of the battery pack enclosure being fabricated by an extrusion process. Extrusion allows material to undergo deformation by the application of a force that causes the material to flow through an orifice or die, thereby causing the material to adopt the cross-sectional profile of the orifice or die. This allows the creation of complex cross-sections and to work with materials that may be able to only withstand compressive and shear stresses.

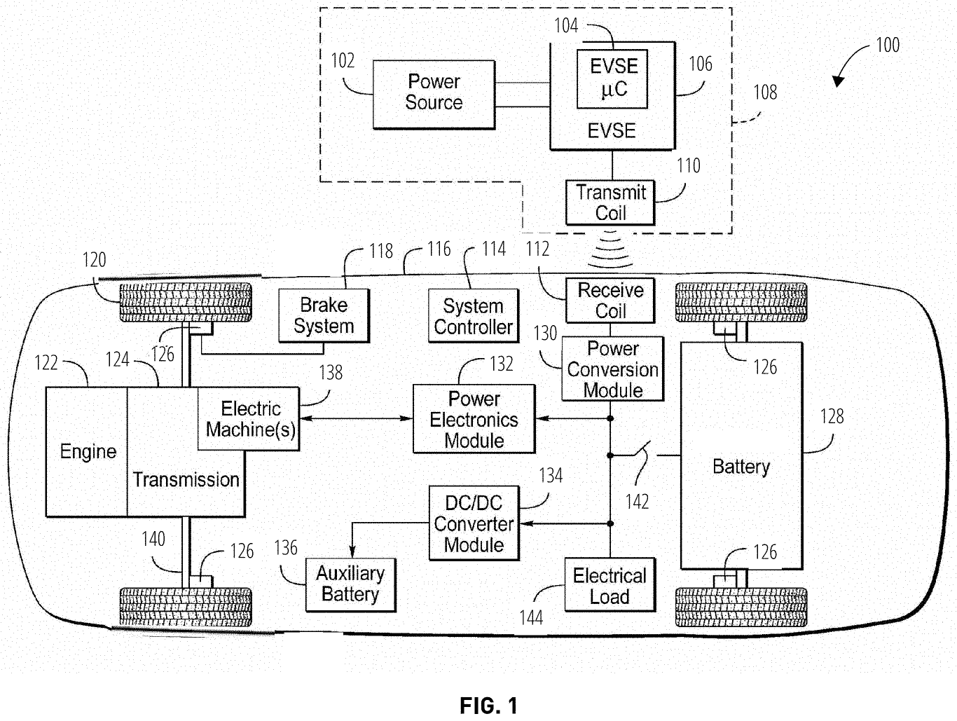

FIG. 1 depicts a schematic of an electric vehicle system 100, in particular, a plug-in hybrid-electric vehicle (PHEV). Although a plug-in hybrid electric vehicle is shown, it will become apparent to a person skilled in the relevant art(s) that the concepts described herein are not limited to PHEV's and extend to other electrified vehicles, including, but not limited to, battery electric vehicles (BEV's), motor vehicles, railed vehicles, watercraft, and aircraft configured to utilize rechargeable electric batteries as their main source of energy to power their drive systems propulsion or that possess an all-electric drivetrain.

The electric vehicle 116 may comprise one or more electric machines 138 mechanically connected to a transmission 124. The electric machines 138 may be capable of operating as a motor or a generator. In addition, the transmission 124 may be mechanically connected to an engine 122, as in a PHEV. The transmission 124 is also mechanically connected to a drive shaft 140 that is mechanically connected to the wheels 120. The electric machines 138 can provide propulsion and deceleration capability when the engine 122 is turned on or off. The electric machines 138 also act as generators and can provide fuel economy benefits by recovering energy that would normally be lost as heat in the friction braking system. The electric machines 138 may also reduce vehicle emissions by allowing the engine 122 to operate at more efficient speeds and allowing the electric vehicle 116 to be operated in electric mode with the engine 122 off in the case of hybrid electric vehicles.

A battery pack 128 stores energy that can be used by the electric machines 138. The battery pack 128 typically provides a high voltage DC output and is electrically connected to one or more power electronics modules 132. One or more contactors 142 may isolate the battery pack 128 from other components when opened and connect the battery pack 128 to other components when closed. To increase the energy densities available for electric vehicles, an arrangement of cells that eliminates unnecessary hardware and makes of extra space may be adapted as described hereinafter. For example, a battery pack configuration may include cells directly placed in an enclosure, with the enclosure also housing other hardware such as, but not limited to the power electronics module 132, DC/DC converter module 134, system controller 114 (such as a battery management system (BMS)), power conversion module 130, battery thermal management system (cooling system and electric heaters) and contactors 142. This consolidated arrangement allows space otherwise occupied separately by said other hardware to be made available for more cells in the battery pack, thus increasing the battery volumetric energy density. The power electronics module 132 is also electrically connected to the electric machines 138 and provides the ability to bi-directionally transfer energy between the battery pack 128 and the electric machines 138. For example, a traction or range-extender battery may provide a DC voltage while the electric machines 138 may operate using a three-phase AC current. The power electronics module 132 may convert the DC voltage to a three-phase AC current for use by the electric machines 138. In a regenerative mode, the power electronics module 132 may convert the three-phase AC current from the electric machines 138 acting as generators to the DC voltage compatible with the battery pack 128. The description herein is equally applicable to a BEV. For a BEV, the transmission 124 may be a gear box connected to an electric machine 14 and the engine 122 may not be present.

In addition to providing energy for propulsion, the battery pack 128 may provide energy for other vehicle electrical systems. A typical system may include a DC/DC converter module 134 that converts the high voltage DC output of the battery pack 128 to a low voltage DC supply that is compatible with other vehicle loads. Other electrical loads 144, such as compressors and electric heaters, may be connected directly to the high-voltage without the use of a DC/DC converter module 134. The low-voltage systems may be electrically connected to an auxiliary battery 136 (e.g., 116V battery). The illustrative embodiments recognize that due to the numerous components that make up the drivetrain of the electric vehicle, it is imperative to make judicious use of space in order to maximize energy storage density.

The electric vehicle 116 may be an electric vehicle such as a BEV or PHEV in which the battery pack 128 may be recharged by a charging station such as a wireless vehicle charging system 108 or a plug in charging station (not shown). The wireless vehicle charging system 108 may include an external power source 102. The external power source 102 may be a connection to an electrical outlet. The external power source 102 may be electrically connected to electric vehicle supply equipment 106 (EVSE). The electric vehicle supply equipment 106 may provide an EVSE controller 104 to provide circuitry and controls to regulate and manage the transfer of energy between the external power source 102 and the electric vehicle 116. The external power source 102 may provide DC or AC electric power to the electric vehicle supply equipment 106. The electric vehicle supply equipment 106 may be coupled to a transmit coil 110 for wirelessly transferring energy to a receive coil 112 of the vehicle 116. The receive coil 112 may be electrically connected to a charger or on-board power conversion module 136. The receive coil 112 may be located on an underside of the vehicle 116. The power conversion module 130 may condition the power supplied to the receive coil 112 to provide the proper voltage and current levels to the battery pack 128. The power conversion module 130 may interface with the electric vehicle supply equipment 106 to coordinate the delivery of power to the electric vehicle 116.

One or more wheel brakes 126 may be provided for decelerating the electric vehicle 116 and preventing motion of the electric vehicle 116. The wheel brakes 126 may be hydraulically actuated, electrically actuated, or some combination thereof. The wheel brakes 126 may be a part of a brake system 118. The brake system 118 may include other components to operate the wheel brakes 126. For simplicity, the figure depicts a single connection between the brake system 118 and one of the wheel brakes 126. A connection between the brake system 118 and the other wheel brakes 126 is implied. The brake system 118 may include a controller to monitor and coordinate the brake system 118. The brake system 118 may monitor the brake components and control the wheel brakes 126 for vehicle deceleration. The brake system 118 may respond to driver commands and may also operate autonomously to implement features such as stability control. The controller of the brake system 118 may implement a method of applying a requested brake force when requested by another controller or sub-function.

One or more electrical loads 144 may be connected to the high-voltage bus. The electrical loads 144 may have an associated controller that operates and controls the electrical loads 144 when appropriate. Examples of electrical loads 144 may be a heating module or an air-conditioning module.

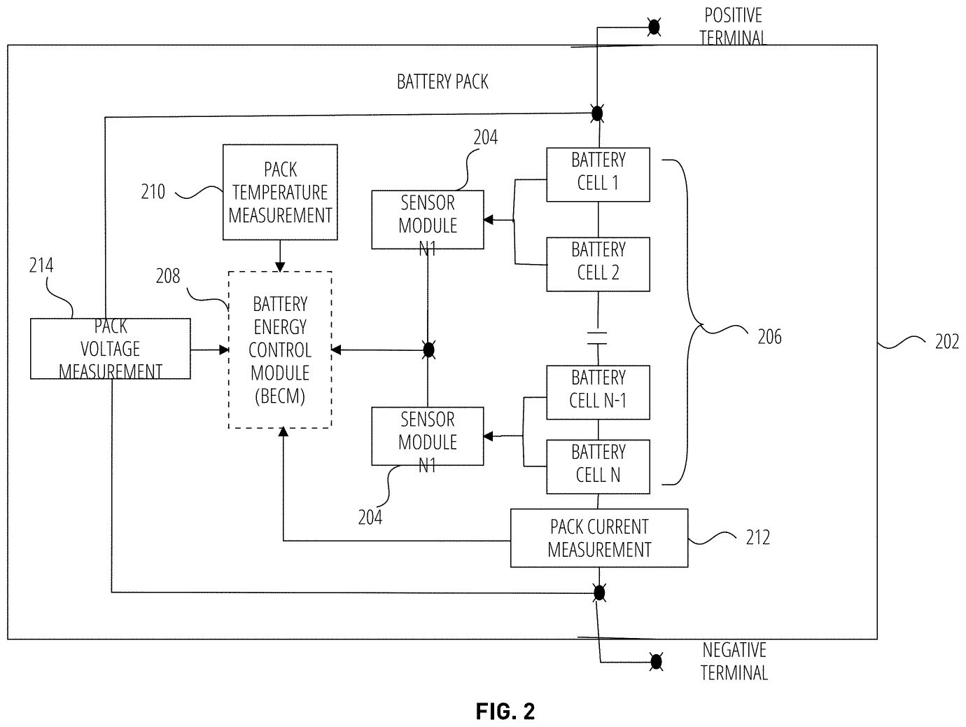

A battery pack 202 such as the battery pack 128 of FIG. 1 may be constructed from a variety of chemical formulations, including, for example, lead acid, nickel-metal hydride (NIMH) or Lithium-Ion. FIG. 2 shows a schematic of the battery pack 202 in a simple series configuration of N battery cell(s) 206. Other battery pack 202, however, may be composed of any number of individual battery cells connected in series or parallel or some combination thereof. The battery pack 202 may have a one or more controllers, such as a Battery Energy Control Module (BECM 208) that monitors and controls the performance of the battery pack 202. The BECM 208 may monitor several battery pack level characteristics such as pack current 212, pack voltage 214 and pack temperature 210. The BECM 208 may have non-volatile memory such that data may be retained when the BECM 208 is in an off condition. Retained data may be available upon the next key cycle. To maximize the number of battery cell(s) 206 in the battery pack 202, electronics of the battery pack 202 including the BECM 208 may be arranged in an electronics compartment as discussed hereinafter.

In addition to the pack level characteristics, there may be battery cell(s) 206 level characteristics that are measured and monitored. For example, the terminal voltage, current, and temperature of each battery cell(s) 206 may be measured. A system may use a sensor module(s) 204 to measure the battery cell(s) 206 characteristics. Depending on the capabilities, the sensor module(s) 204 may measure the characteristics of one or multiple of the battery cell(s) 206. Each sensor module(s) 204 may transfer the measurements to the BECM 208 for further processing and coordination. The sensor module(s) 204 may transfer signals in analog or digital form to the BECM 208. In some embodiments, the sensor module(s) 204 functionality may be incorporated internally to the BECM 208. That is, the sensor module(s) 204 hardware may be integrated as part of the circuitry in the BECM 208 and the BECM 208 may handle the processing of raw signals. Further, a battery management system (BMS) may form or be part of the BECM 208.

It may be useful to calculate various characteristics of the battery pack. Quantities such a battery power capability and battery state of charge may be useful for controlling the operation of the battery pack as well as any electrical loads receiving power from the battery pack. Battery power capability is a measure of the maximum amount of power the battery can provide or the maximum amount of power that the battery can receive for the next specified time period, for example, 1 second or less than one second. Knowing the battery power capability allows electrical loads to be managed such that the power requested is within limits that the battery can handle.

Battery pack state of charge (SOC) gives an indication of how much charge remains in the battery pack. The battery pack SOC may be output to inform the driver of how much charge remains in the battery pack, similar to a fuel gauge. The battery pack SOC may also be used to control the operation of an electric vehicle. Calculation of battery pack or cell SOC can be accomplished by a variety of methods. One possible method of calculating battery SOC is to perform an integration of the battery pack current over time. One possible disadvantage to this method is that the current measurement may be noisy. Possible inaccuracy in the state of charge may occur due to the integration of this noisy signal over time. Calculation of battery pack or cell SOC can also be accomplished by using an observer, whereas a battery model is used for construction of the observer, with measurements of battery current, terminal voltage, and temperature. Battery model parameters may be identified through recursive estimation based on such measurements.

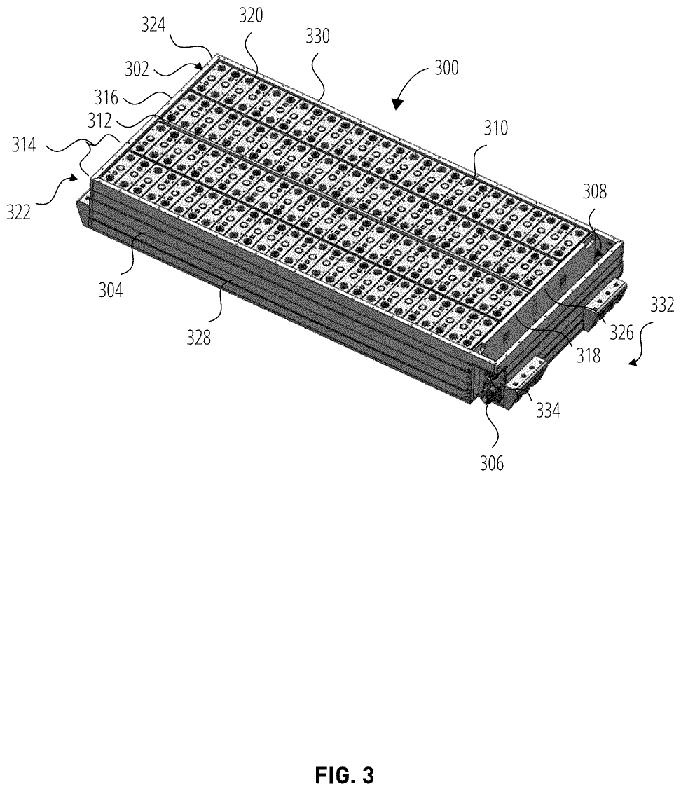

A battery management system such as system controller 114 may estimate various battery parameters based on the sensor measurements. In addition to the BECM 208, other electronics such as the sensor module(s) 204 and the battery management system, collectively referred to herein as battery pack electronics control modules may be fully or partially arranged in an electronics compartment 308 (shown in FIG. 3).

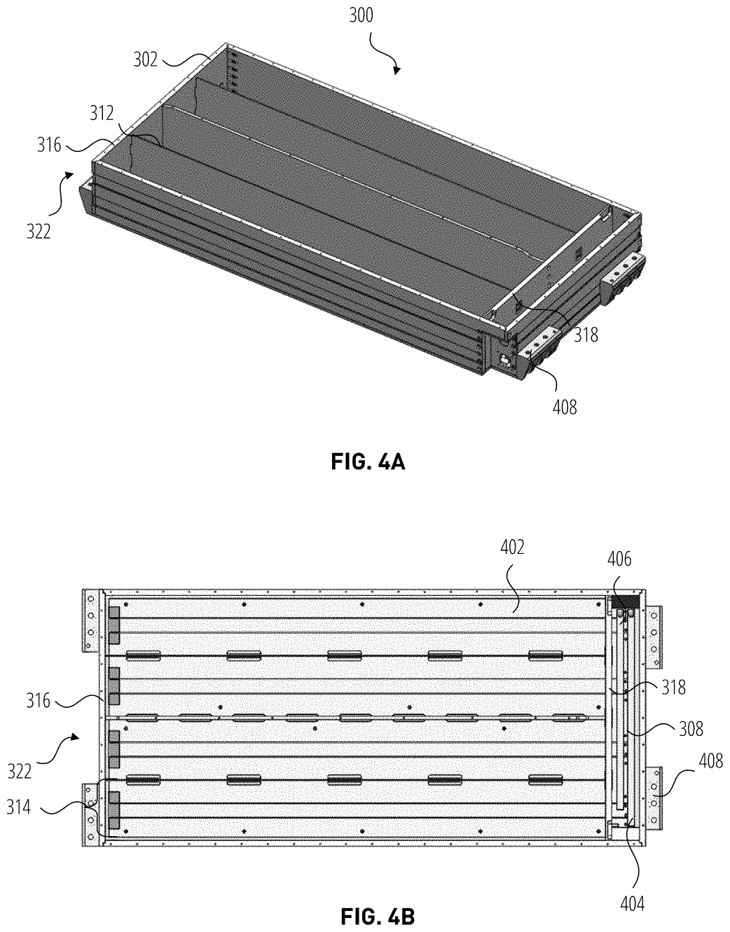

Turning to FIG. 3, a battery pack 300 in which illustrative embodiments may be implemented will now be described. The battery pack 300, in one example embodiment, can form or be included in the battery pack 128 of FIG. 1 or the battery pack 202 of FIG. 2. The battery pack 300 includes an enclosure 302 having at least four sidewalls 304 that are connected by a base 402 (FIG. 4B). The sidewalls 304 include a first sidewall 324, a second sidewall 326, a third sidewall 328 and a fourth sidewall 330. The base 402 has one or more rows 314 on which the plurality of cells 310 are arranged. The cells 310 may be arranged in series or in parallel or both and the arrangement may be based on the manner in which the cell terminals 320 are connected. Each of the plurality of cells 310 has a large wall surface and a small wall surface, i.e. a surface area of the small wall surface is less that a surface area of the large wall surface. For each row 314 of the one or more rows, the plurality of cells 310 are arranged such their large wall surfaces are parallel to each other. Further, each row 314 may be separated from another by a divider 312.

In an illustrative embodiment, two sidewalls 304 of the pack structure, in particular the first 324 and second sidewalls 326 form a first end plate 316 and a second end plate 318 respectively. The end plates may be made from materials such as, but not limited to steel, plastic and aluminum. In contrast to conventional battery packs that may use other components to apply compressive force to battery modules and/or cells within the pack, in embodiments disclosed herein the end plates 316, 318 may apply compressive force to the cells 310 within the pack structure, thereby eliminating the need for straps or other similar components to provide compressive force. The second end plate 318 may be stationary while the first end plate 316 may be adjustable during an arrangement or packing process of the cells to apply compressive load on the plurality of cells 310. The first end plate 316 is secured attached or fastened to the remainder of the enclosure to apply the compressive load is applied in a direction perpendicular to the large wall surfaces as shown in FIG. 3. The first end plate 316 may be attached by any attachment process such as by the use of bolts or by welding it to the base 402, the third 328 and the fourth sidewalls 330 at a first end 322. Thus, by a single operation, the battery pack 300 is compressed and sealed on two sides including up to all five sides. In contrast, conventional battery packs that compress cells or modules within the pack typically require the cells to be compressed prior to insertion into the pack structure. For example, cells typically may be placed under a compressive force and held in place by straps, clamps, or the like, so that the compressed stack of cells can be placed within a housing. In embodiments disclosed herein, such additional compressive component(s) may be omitted due to the compressive force provided by the pack structure itself, such as the end plates 316, 318. In an illustrative embodiment, the battery pack 300 has two end plates and is compressed on two sides that each have an end plate such that the pack is sealed on all five sides. A top cover (not shown) is subsequently affixed to the top of the battery pack to seal the battery pack on all six sides.

Further, the body of the enclosure is made from a plurality of extruded parts that are mechanically connected such as by bolts, or welded/glued/adhered together. In an illustrative embodiment, the divider 312 and sidewalls 304 are welded to the base 402. In the illustrative embodiment, the divider, sidewalls 304 and/or base 402 are separate extrusions and channels in the base 402 and/or sidewalls 304, produced by the extrusion process, are configured for cooling the cells 310 as described hereinafter. Depending on the size of the enclosure, such as when a smaller than conventional size is needed, or a single row 314 is needed, the base 402 and sidewalls 304 may be manufactured as a single extrusion.

In an illustrative embodiment, an electronics compartment 308 is disposed on a second end 332 of the battery pack 300. The electronics compartment 308 stores the battery pack electronics control modules as discussed herein. It may also house inlet and outlet fluid lines for a fluid channel of the base 402 as well as the connectors (low voltage connector 334 and high voltage connector 306) of the battery pack.

FIG. 4A illustrates an enclosure 302 of the battery pack 300 in accordance with an illustrative embodiment. The enclosure 302 has a plurality of dividers 312 that are connected to the base and/or the first end plate 316 and second end plate 318 to separate cells of the battery pack. The dividers are permanently or removable affixed to the base and end plates. The enclosure also has one or more 408 vehicle mounts 408 for mounting, attaching or fixing the battery pack 300 to the electric vehicle. In an example configuration, bracketry on the vehicle chassis (not shown) are joined to the vehicle mount 408 to mount the battery pack into the electric vehicle.

FIG. 4B shows a top view of the enclosure 302. In addition to housing the electronic control modules, the electronics compartment 308 may also house the inlet conduit 404 and outlet conduit 406. The inlet conduit supplies a cooling fluid to fluid channels of the base 402 whereas the outlet conduit transports the cooling fluid away from the fluid channels of the base 402.

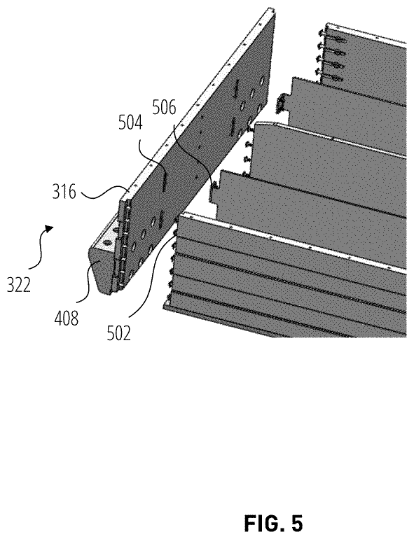

Turning now to FIG. 5, a perspective view of a section of the enclosure according to an illustrative embodiment is shown. The first end plate 316 of the enclosure 302 is configured to be affixed to the sidewalls 304 and/or dividers 312 at a first end 322 in a compression process. The compression process is conducted after cells 310 of the battery pack 300 are arranged on the base 402. In an illustrative embodiment, the first end plate 316 is designed to have holes 504 configured to receive one or more extensions 506 of the dividers 312 and or sidewalls 304. The extensions 506 are then bended to lock the first end plate 316 into place. The extensions may also be interlocking mechanisms 502 that don't need to be bended. Alternately, the first end plate 316 is welded or bolted to the sidewalls 304 and/or dividers. In some embodiments, the battery pack may be formed from a three-walled structure into which the cells are placed prior to compression. The fourth sidewall, such as the end plate 316, may then be placed into position to provide at least a portion of the compressive force to the cells 310 within the battery pack. Such an arrangement may be used even where the final wall (such as end plate 316 or 318) is removeable such as for servicing of the battery pack. The vehicle mount 408 may be configured as part of the first end plate 316.

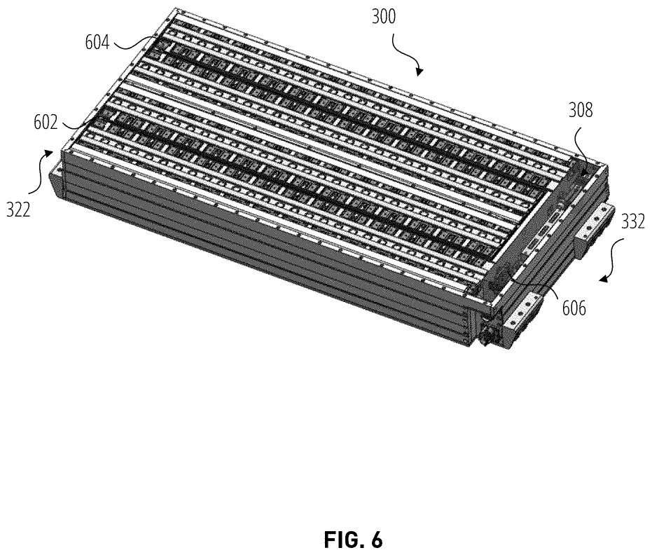

FIG. 6 perspective view of the battery pack 300 having cells 310 arranged therein. The battery pack 300 also has one or more busbars 602 that are connected to the cells 310 through electrical connectors 604. The cells 310 in a row 314 may have adhesives between each other to hold them together. The electronics compartment 308 contains the battery pack electronics control modules 606. By arranging electronic control modules in the electronics compartment 308, space is saved and made available for additional cells to increase the volumetric energy density of the battery pack.

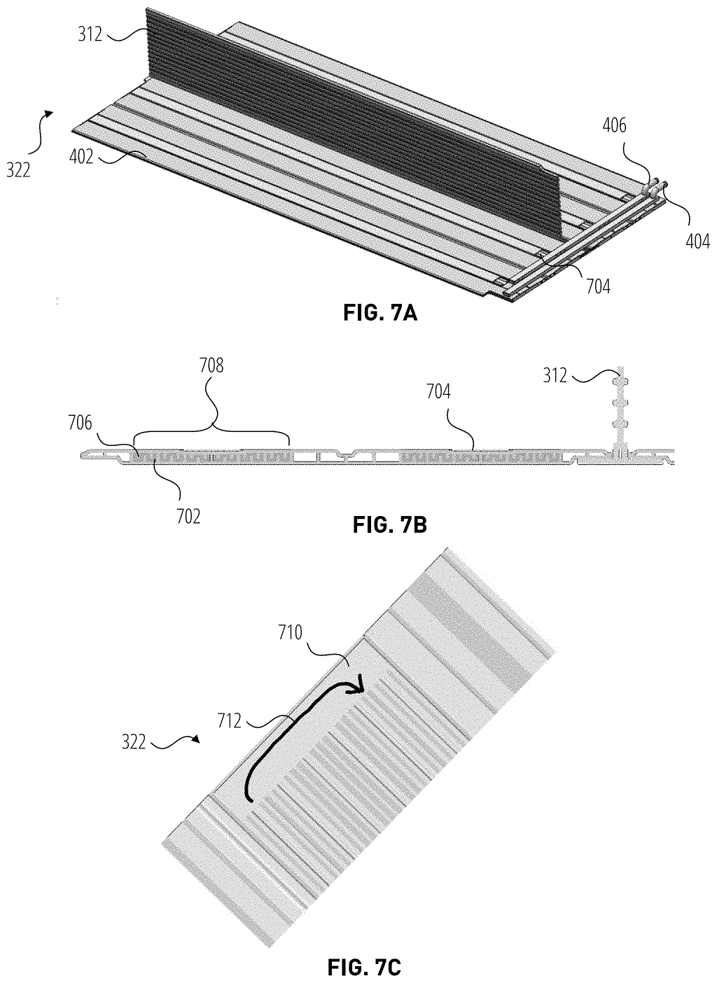

FIG. 7A and FIG. 7B show a perspective view and a side view of the base 402 having a divider 312 respectively. The base 402 has a plurality fluid channels 702 that are formed during an extrusion process. Each fluid channel 702 has an undulating profile formed by fins 706 of the base 402. Said undulation channel profile configuration significantly increases the surface area of the base in contact with a cooling liquid (not shown) compared to conventional fluid channels such that rapid cooling of the cells 310 are achieved. Of course, other profile shapes that provide symmetrical channels or increase a total surface area for contact of the cooling liquid may be obtained and this is not meant to be limiting. Each fluid channel 702 allows the cooling liquid to flow in it in one direction. In an illustrative embodiment as shown in FIG. 7B, each channel section 708 has a plurality of fluid channels, e.g. six fluid channels 702. The first “n” number (e.g. three) of adjacent fluid channels 702 on one end of the channel section 708, allow the cooling liquid to flow in a same direction and the remaining adjacent fluid channels on the opposite end of the channel section 708 allow the cooling liquid to flow in an opposing direction. This is facilitated by a footer 710 configuration that provides space for fluid flow 712 as shown in FIG. 7C, as well as by the use of a pump (not shown), which provides a pressure differential for the fluid channels through the inlet 404 and outlet conduits 406 that are connected respectively to said first “n” (e.g. three) adjacent fluid channels and said remaining adjacent fluid channels. Of course, this is non-limiting, and other configurations such as more than six fluid channels 702 per channel section 708 can be obtained in light of this specification. The examples in this disclosure are used only for the clarity of the description and are not limiting to the illustrative embodiments. Additional operations, actions, tasks, activities, and manipulations will be conceivable from this disclosure, and the same are contemplated within the scope of the illustrative embodiments.

In an illustrative embodiment, the footer 710 is obtained by machining off a portion of the fins 706 proximal to the first end 322. By configuring the base 402 of the enclosure 302 as the cooling structure instead of using an additional separate plate, more space is made available for occupation by the plurality of cells 310 of the battery pack 300. Further, the base 402 may have a heater 704 for heating the cells in cold temperature environments. The prevents the cells 310 from getting so cold that they can't be charged, or their resistance so high that appropriate currents can't be obtained. The heater may be made of a flexible circuit and adhered to the extrusion in some embodiments. A gap pad/filler or other thermal interface material may cover the circuit. Further another material such as a thermal epoxy or another gap filler may be placed between the extrusion/base and the cells.

Embodiments disclosed herein may provide more efficient, stronger, and/or more stable arrangements of modules within the battery pack. For example, conventional battery packs used in similar situations may be formed from a single-piece extrusion, where the battery cells or modules are compressed externally to the pack structure and then inserted into the extruded housing. Such an arrangement generally cannot be used at the scale necessary for mass manufacture or to provide reliable housing and battery pack structure for applications such as electric vehicles as disclosed herein. In contrast, embodiments disclosed herein use the outer walls of the battery pack itself to provide compressive force to the cells within the pack, and the arrangements and fabrication techniques disclosed herein are more suited for mass manufacture of battery packs suited for EV use.

Embodiments disclosed herein also may be designed, configured, and fabricated to be particularly suited for use in EV applications.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A battery pack comprising:
an enclosure having at least four sidewalls connected to a base;
a plurality of cells arranged on one or more rows of the base, with each cell of the plurality of cells having a large wall surface and a small wall surface, a surface area of the small wall surface being less that a surface area of the large wall surface;
wherein, for each row of the one or more rows, cells of the plurality of cells are arranged such their large wall surfaces are parallel to each other, and
wherein a body of the enclosure is made from extruded parts.

2. The battery pack of claim 1, wherein two sidewalls of the at least four sidewalls are end plates that are arranged parallel to the large wall surfaces with one of the two sidewalls being adaptable to apply compressive force to the plurality of cells.

3. The battery pack of claim 1, wherein the at least four sidewalls are mechanically attached or welded to the base.

4. The battery pack of claim 1, wherein the enclosure comprises an electronics compartment that houses one or more battery pack electronics control modules.

5. The battery pack of claim 4, wherein the battery pack electronic control modules include one or more modules selected from the list consisting of a Battery Energy Control Module (BECM), a sensor module(s), a high voltage connector and a low voltage connector.

6. The battery pack of claim 1, wherein the base is an extrusion that comprises a plurality of fluid channels configured to cool the battery pack, wherein the plurality of fluid channels extend along a length of the base.

7. The battery pack of claim 6, at least one channel of the plurality of fluid channels has an undulating or substantially undulating profile that maximizes a surface area of said at least one channel in comparison with a conventional channel having a substantially rectangular profile.

8. The battery pack of claim 6, wherein the base has a footer made from machined-off fins at a first end of the battery pack to allow flow of the cooling liquid from first fluid channels at one end of a channel section to second fluid channels at another end of the channel section.

9. The battery pack of claim 1, wherein one or more heating elements are disposed across a length of the base.

10. The battery pack of claim 1, wherein at least 70 percent of a volume of the battery pack is occupied by cells.

11. The battery pack of claim 1, wherein each row of the at one or more rows has a same number of cells.

12. The battery pack of claim 1, wherein the battery pack has at least two rows and each row is separated from an adjacent row by a divider.

13. The battery pack of claim 1, wherein two sidewalls of the at least four sidewalls have one or more vehicle mounts adapted for attaching the battery pack to a base of an electric vehicle.

14. The battery pack of claim 1, wherein two other sidewalls of the at least four sidewalls are arranged opposite each other along a plane of the small wall surface to confine to the plurality of cells.

15. The battery pack of claim 1, further comprising one or more busbars connected to the plurality of cells through electrical connectors.

16. A battery pack comprising:
an enclosure having at least four sidewalls connected by a base, the base being an extrusion; and
a first endplate that forms one of said at least four sidewalls, the first endplate configured to be welded or attached to the base to apply compressive load to a plurality of cells;
wherein a body of the enclosure is made from extruded parts and the at least four sidewalls are mechanically attached or welded to the base.

17. A method for producing a battery pack, the method comprising:
forming an enclosure that includes a base and at least four sidewalls, the base being formed by extrusion to include a plurality of fluid channels;
providing a plurality of cells with each of the plurality of cells having a large wall surface and a small wall surface, a surface area of the small wall surface being less that a surface area of the large wall surface;
arranging the plurality of cells on the base such that their large wall surfaces are parallel to each other;
compressing the plurality of cells using a first end plate by applying said first end plate to the plurality of cells in a direction perpendicular to the large wall surfaces,
wherein at least one of the sidewalls is mechanically attached or welded to the base.

18. The method of claim 17, further comprising:
creating a pressure differential, by a pump, to move a cooling liquid through the plurality of fluid channels to cool the plurality of cells.

19. The method of claim 17, further comprising:
providing one or more heating elements disposed on the base to heat the plurality of cells in cold temperatures.

20. The method of claim 17, further comprising:
forming, as part of the enclosure, an electronics compartment disposed on a second end of the battery pack to house one or more battery pack electronics control modules.

21. The method of claim 17, further comprising:
machining off fins of the base to create a footer at a first end of the battery pack to allow flow of the cooling liquid from first fluid channels at one end of a channel section to second fluid channels at another end of the channel section to cool the plurality of cells.

22. The method of claim 17, further comprising forming the enclosure and arranging the plurality of cells on the base of the enclosure such that at least 70% of a volume of the battery pack is occupied by the plurality of cells.
